(19) United States
(12) Patent Application Publication
(10) Pub. No.: US 2026/0351244 A1
(43) Pub. Date: Nov. 5, 2026

(54) SPEECH SYNTHESIS METHOD, APPARATUS, ELECTRONIC DEVICE, AND STORAGE MEDIUM

(71) Applicant: Douyin Vision Co., Ltd., Beijing (CN)

(72) Inventors: Zhengxi LIU, Beijing (CN); Qiao TIAN, Beijing (CN); Chumin LI, Beijing (CN); Xudong LIU, Beijing (CN); Menglin WU, Beijing (CN); Yuping WANG, Beijing (CN)

(21) Appl. No.: 19/112,528

(22) PCT Filed: Nov. 9, 2023
(86) PCT No.: PCT/CN2023/130687

§ 371 Date: Mar. 17, 2025

(30) Foreign Application Priority Data
Mar. 27, 2023 (CN) 202310309011.7

(51) Int. Cl. G10L 13/10; G10L 13/027; G10L 13/047

(52) U.S. Cl. CPC G10L 13/10; G10L 13/027; G10L 13/047; G10L 2013/105

(57) ABSTRACT

A speech synthesis method, an apparatus, an electronic device, and a storage medium. The method comprises: acquiring a text to be processed, and inputting the text to be processed into a speech synthesis model; predicting, by the speech synthesis model and according to linguistic features of the text to be processed, distribution information about prosodic features of each phoneme in the text to be processed; adjusting, based on the distribution information about the prosodic features of each phoneme in the text to be processed, linguistic features of the text to be processed; generating, according to the adjusted linguistic features of the text to be processed, speech data corresponding to the text to be processed.

### CROSS-REFERENCE TO RELATED APPLICATION(S)

This application is a national stage application filed under 35 U.S.C. 371 based on International Patent Application No. PCT/CN2023/130687, filed Nov. 9, 2023, which claims priority to Chinese Application No. 202310309011.7 filed on Mar. 27, 2023 and entitled “Speech synthesis method, apparatus, electronic device, and storage medium”, the disclosures of which are incorporated herein by reference in their entities.

### FIELD

The present disclosure relates to the field of speech processing technology, and more particularly to a speech synthesis method, an apparatus, an electronic device, and a storage medium.

### SUMMARY

In a first aspect of the present disclosure, there is provided a speech synthesis method. The method comprises:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, linguistic features of the text to be processed;
generating, according to the adjusted linguistic features of the text to be processed, speech data corresponding to the text to be processed.

In a second aspect of the present disclosure, there is provided a speech synthesis apparatus. The apparatus comprises:
a text acquisition unit for acquiring a text to be processed, and inputting the text to be processed into
a speech synthesis model;
a distribution prediction unit for predicting, by the speech synthesis model and according to linguistic features of the text to be processed, distribution information about prosodic features of each phoneme in the text to be processed;
a feature adjustment unit for adjusting, based on the distribution information about the prosodic features of each phoneme in the text to be processed, linguistic features of the text to be processed;
a data generation unit for generating, according to the adjusted linguistic features of the text to be processed, speech data corresponding to the text to be processed.

In a third aspect of the present disclosure, there is provided an electronic device comprising: a processor; and, a memory configured to store computer-executable instructions that, when executed, cause the processor to implement the steps of the method of the first aspect.

In a fourth aspect of the present disclosure, there is provided a computer-readable storage medium for storing computer-executable instructions that, when executed by a processor, implement the steps of the method of the first aspect.

### BRIEF DESCRIPTION OF THE DRAWINGS

In order to more clearly illustrate one or more embodiments of the present disclosure or the technical solutions in the prior art, a brief description of the embodiments or the drawings used in the description of the prior art is given below. It is obvious that the drawings in the description below are only some embodiments described in the present disclosure. For a person skilled in the art, other drawings can be obtained according to these drawings without involving any inventive effort;

FIG. 1 illustrates a schematic flow diagram of a speech synthesis method according to an embodiment of the present disclosure;

FIG. 2a illustrates a structure diagram of a speech synthesis model according to an embodiment of the present disclosure;

FIG. 2b illustrates a schematic diagram of the speech synthesis principle of the speech synthesis model corresponding to FIG. 2a;

FIG. 3 illustrates a schematic flow diagram of a speech synthesis method according to another embodiment of the present disclosure;

FIG. 4a illustrates a structure diagram of a speech synthesis network according to an embodiment of the present disclosure;

FIG. 4b illustrates a schematic diagram of the training principle of the speech synthesis network corresponding to FIG. 4a;

FIG. 5 illustrates a schematic diagram of a training flow of a speech synthesis model according to an embodiment of the present disclosure;

FIG. 6 illustrates a schematic diagram of the principle of a posteriori encoder and an acoustic encoder according to an embodiment of the present disclosure;

FIG. 7 illustrates a schematic diagram of a training flow of a speech synthesis model provided by another embodiment of the present disclosure;

FIG. 8 illustrates a structure diagram of a speech synthesis apparatus according to an embodiment of the present disclosure;

FIG. 9 illustrates a structure diagram of an electronic device according to an embodiment of the present disclosure.

### DETAILED DESCRIPTION OF EMBODIMENTS

In order that those skilled in the art may better understand the subject matter of in one or more embodiments of the present disclosure, a clear and complete description of subject matter of one or more embodiments of the present disclosure is set forth below in connection with the drawings of one or more embodiments of the disclosure. Obviously, the described embodiments are merely illustrative of some, but not all embodiments of the present disclosure. On the basis of one or more embodiments of the present disclosure, all other embodiments obtained by a person of ordinary skill in the art without inventive effort should fall within the scope of the present disclosure.

It should be understood that prior to using the technical solutions disclosed in the various embodiments of the present disclosure, the user shall be informed of the type, scope of use, use scenario, etc. of personal information involved in the present disclosure in an appropriate manner according to relevant laws and regulations and the use's authorization shall be obtained.

For example, in response to receiving a user's active request, prompt information is sent to the user to explicitly prompt the user that the operation requested to be performed will require obtaining and using personal information to the user. Accordingly, a user can autonomously select whether to provide personal information to software or hardware, such as an electronic device, an application program, a server or a storage medium, which executes the operation of the technical solution of the present disclosure, according to prompt information.

As an alternative but non-limiting implementation, in response to receiving an active request from a user, the prompt message may be sent to the user, for example, in the form of a pop-up window in which the prompt message may be presented in text. In addition, the pop-up window may also carry a selection control for the user to select “agree” or “disagree” to provide personal information to the electronic device.

It is to be understood that the above-described notification and user authorization processes are merely illustrative and not limiting of implementations of the present disclosure, and that other ways of satisfying relevant laws and regulations may also be applied to implementations of the present disclosure.

It is understood that the data involved in this technical solution (including but not limited to the data itself and the acquisition or use of the data) shall comply with the requirements of relevant laws and regulations and relevant provisions.

With the development of deep learning, high-quality speech data for a text can be generated by a neural network model. Conventional neural network models include a two-stage sub-model, a first-stage sub-model for generating an intermediate speech representation, such as a Mel-spectrogram, from an input text, a second-stage sub-model for synthesizing speech data using a vocoder with the generated intermediate speech representation. Since the two-stage neural network model requires two-stage sub-models to be trained separately during training, the prior art proposes an end-to-end speech synthesis model capable of generating corresponding speech data directly from the input text.

However, in the prior art, a fixed prosodic expression is generated for each phoneme, rendering that the generated speech data sounds mechanized, rendering low expressiveness and poor quality of the generated speech data.

The present disclosure provides a speech synthesis method, an apparatus, an electronic device, and a storage medium to improve expressiveness and quality of synthesized speech data.

Embodiments of the present disclosure provide a speech synthesis method capable of improving expressiveness of synthesized speech data and improving quality of the synthesized speech data. The speech synthesis method can be applied in a terminal device and executed by the terminal device, and the terminal device generates corresponding speech data on the basis of text information input by a user. The terminal device includes, but is not limited to, a mobile phone, a tablet computer, a vehicle-mounted computer, a wearable device, etc. The voice synthesis method provided by the embodiments of the present disclosure can be applied to a variety of scenes, for example, an intelligent voice interaction scene of an intelligent home, an intelligent customer service, a literary voiced reading scene, a game task broadcasting scene, an intelligent voice navigation scene, etc. and the embodiments of the present disclosure are not limited thereto. Illustratively, in a literary aloud reading scenario, for example, for an article on a web page, the text on the web page can be acquired in response to a user's triggering operation on the loud reading, so that the text on the web page can be processed using a speech synthesis method provided by an embodiment of the present disclosure, and speech data corresponding to the text can be obtained, thereby enabling the loud reading of the article on the web page.

In one or more embodiments of the present disclosure, the following steps are included: acquiring a text to be processed, and inputting the text to be processed into a speech synthesis model; predicting, by the speech synthesis model and according to linguistic features of the text to be processed, distribution information about prosodic features of each phoneme in the text to be processed; adjusting, based on the distribution information about the prosodic features of each phoneme in the text to be processed, linguistic features of the text to be processed; generating, according to the adjusted linguistic features of the text to be processed, speech data corresponding to the text to be processed. With the speech synthesis model in this embodiment, it is possible to predict distribution information about prosodic features of each phoneme in the text to be processed so as to improve prosodic modeling capability of the speech synthesis model on the basis of the prosodic features of the text. In this way, the speech synthesis model can obtain more diversified prosodic changes and thereby the prosody of the same phoneme in different contexts is different and conforms to the context, improving the diversity and stability of the prosody, the expressiveness and quality of the synthesized speech data.

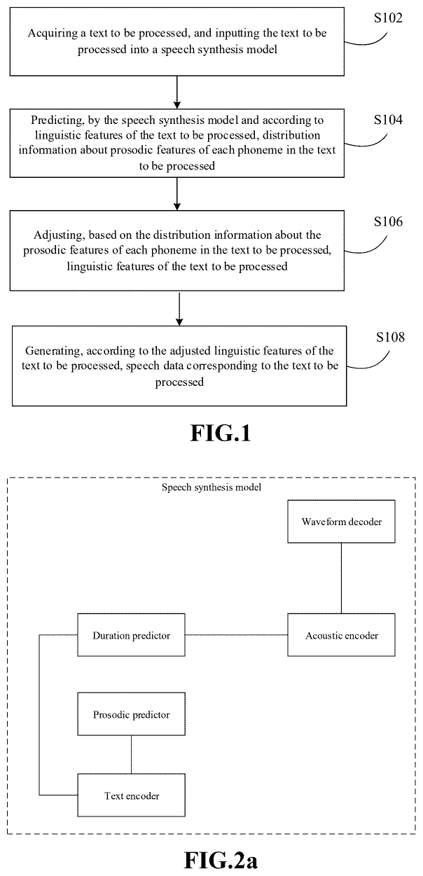

FIG. 1 illustrates a schematic flow diagram of a speech synthesis method according to an embodiment of the present disclosure
Step S102, acquiring a text to be processed, and inputting the text to be processed into a speech synthesis model;
Step S104, predicting, by the speech synthesis model and according to linguistic features of the text to be processed, distribution information about prosodic features of each phoneme in the text to be processed;
Step S106, adjusting, based on the distribution information about the prosodic features of each phoneme in the text to be processed, linguistic features of the text to be processed;
Step S108, generating, according to the adjusted linguistic features of the text to be processed, speech data corresponding to the text to be processed.

In one or more embodiments of the present disclosure, the following steps are included: acquiring a text to be processed, and inputting the text to be processed into a speech synthesis model; predicting, by the speech synthesis model and according to linguistic features of the text to be processed, distribution information about prosodic features of each phoneme in the text to be processed; adjusting, based on the distribution information about the prosodic features of each phoneme in the text to be processed, linguistic features of the text to be processed; generating, according to the adjusted linguistic features of the text to be processed, speech data corresponding to the text to be processed. With the speech synthesis model in this embodiment, it is possible to predict distribution information about prosodic features of each phoneme in the text to be processed so as to improve prosodic modeling capability of the speech synthesis model on the basis of the prosodic features of the text. In this way, the speech synthesis model can obtain more diversified prosodic changes and thereby the prosody of the same phoneme in different contexts is different and conforms to the context, improving the diversity and stability of the prosody, the expressiveness and quality of the synthesized speech data.

In a specific embodiment, the distribution information about prosodic features of each phoneme in the text to be processed obtained by the above-mentioned prediction is no longer assumed to conform to a standard normal distribution, that is to say, the variance of the predicted distribution information is not necessarily equal to the variance of the standard normal distribution, and/or the mean value of the predicted distribution information is not necessarily equal to the mean value of the standard normal distribution. By predicting the distribution information about the prosodic features which does not necessarily conform to the standard normal distribution, not only the problem of excessive smoothing in prosodic prediction is alleviated, but also the prosodic modeling capability is increased compared with assuming the prosodic distribution as a standard normal distribution in the prior art. More diverse prosodic changes can be obtained, so that the prosody of the same phoneme in different contexts is different and consistent with the context of the context, which improves the diversity and stability of the prosody, thereby improving the expressiveness of the synthesized speech data and improving the quality of the synthesized speech data.

In order to facilitate the understanding of the speech synthesis method in the present embodiment, some basic concepts will first be described.

Text: it refers to written language in the form of characters, for example, a novel text on the network is a text, and the simplest text can be exemplified as “ni hao”.

Phonemes: it is the smallest unit of speech divided according to the natural properties of speech, and is analyzed according to the pronunciation action in syllables. A pronunciation action constitutes a phoneme. For example, the phoneme corresponding to the text “ni hao” is: n, i, h, ao, where ao acts as a phoneme since it corresponds to a pronunciation action.

Rhythm: it includes, but is not limited to, the pronunciation duration of each phoneme, the duration of the pause between each phoneme, the pitch of each phoneme, etc. A piece of complete speech data comprises three elements of text, timbre and prosody, and the remaining information in the speech data heard by the human ear except the text and timbre elements can be classified as prosody elements.

In the above-mentioned step S102, the text to be processed is acquired, and the text to be processed is a text required to generate corresponding speech data, for example, the text to be processed is a piece of video blank edited by a user. The pending text is input to a pre-trained speech synthesis model. In this embodiment, a speech synthesis model is pre-trained, and the speech synthesis model can process an input text and output corresponding speech data, and the speech data can achieve the effect of broadcasting the input text after being played.

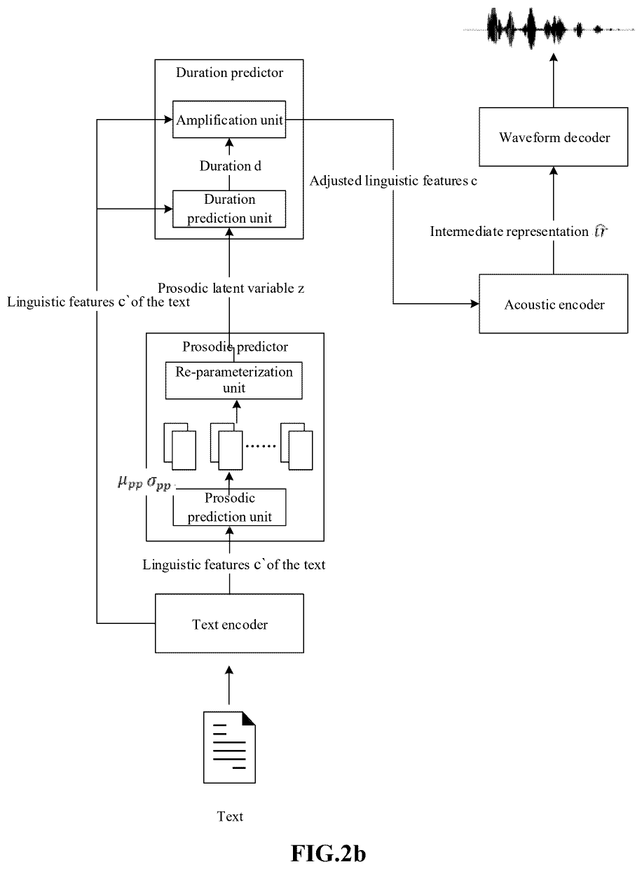

FIG. 2a illustrates a structure diagram of a speech synthesis model according to an embodiment of the present disclosure. As shown in FIG. 2a, the model comprises: a text encoder, a prosodic predictor, a duration predictor, an acoustic encoder and a waveform decoder, wherein the text encoder is respectively connected to the prosodic predictor and the duration predictor, and the duration predictor is connected to the acoustic encoder, and the acoustic encoder is connected to the waveform decoder.

FIG. 2b illustrates a schematic diagram of the speech synthesis principle of a speech synthesis model corresponding to FIG. 2a. As shown in FIG. 2b, the speech synthesis principle of the speech synthesis model is:
1. inputting the text into the speech synthesis model, the text encoder extracting linguistic features c′ of the input text and outputting same to a prosody predictor and a duration predictor;
2. the prosodic prediction unit in the prosodic predictor predicting the distribution information about prosodic features of each phoneme in the text on the basis of the linguistic features c′ of the text, μ_pp representing a mean vector in the distribution information, σₚₚ representing a variance vector in the distribution information; a re-parameterization unit in the prosodic predictor performing re-parameterization processing on the distribution information to obtain a prosodic latent variable z at a phoneme level corresponding to the text, and outputting the prosodic latent variable z at a phoneme level corresponding to the text to the duration predictor;
3. the duration prediction unit in the duration predictor predicting a pronunciation duration d of each phoneme in the text according to the prosodic latent variable z at a phoneme level corresponding to the text and linguistic features c′ of the text, and an amplification unit in the duration predictor performing length amplification on the linguistic features c′ of the text according to the pronunciation duration d of each phoneme in the text to obtain an adjusted linguistic features c of the text, and outputting the adjusted linguistic features c of the text to an acoustic encoder;
4. the acoustic encoder performing acoustic encoding on the adjusted linguistic features c of the text to obtain an intermediate representation [symbol] corresponding to the text, and outputting the same to the waveform decoder;
5. the waveform decoder decoding the intermediate representation [symbol] to obtain speech data corresponding to the text.

When the speech synthesis model is applied to the present embodiment, the text input to the speech synthesis model is the text to be processed in the step S102.

In the above-mentioned step S104, the distribution information about prosodic features of each phoneme in the text to be processed is predicted according to the linguistic features of the text to be processed be means of the speech synthesis network. In one embodiment, the distribution information does not necessarily conform to a standard normal distribution.

Specifically, with the speech synthesis model in this embodiment, it is possible to predict the distribution information about prosodic features of each phoneme in the text to be processed. Taking the text to be processed being a sentence and comprising 10 phonemes as an example, each phoneme has its own prosodic features, and thus has 10 prosodic features; each prosodic features can be represented in the form of a vector, and thus a vector has 10 prosodic features; by statistical distribution, the vector of each prosodic features can be converted into a mean vector and a variance vector, and the mean vector and the variance vector constitute distribution information about each prosodic features. Therefore, the distribution information about prosodic features of each phoneme in the text to be processed predicted by the speech synthesis model comprises the mean vector and the variance vector of the prosodic features of each phoneme in the text to be processed.

For example, for the text “ni hao”, the distribution information about prosodic features of each phoneme thereof may be exemplified as: (mean n1, variance n2), (mean i1, variance i2), (mean h1, variance h2), (mean ao1, variance ao2), mean vectors and variance vectors respectively representing prosodic features of phonemes n, i, h, ao.

Traditional speech synthesis models assume that the distribution information about prosodic features of each phoneme in the text conforms to the standard normal distribution, that is, the mean vector and the variance vector of the prosodic features of each phoneme are the mean vector and the variance vector of the standard normal distribution, but, such assumption has the problem of excessive smoothing in prosodic prediction. In the embodiments of the present disclosure, the distribution information about prosodic features of each phoneme in the text is no longer assumed to necessarily conform to a standard normal distribution, and can be abstracted as a non-standard normal distribution, namely, the variance of the predicted distribution information is not necessarily equal to the variance of the standard normal distribution, and/or the mean value of the predicted distribution information is not necessarily equal to the mean value of the standard normal distribution. In the embodiments of the present disclosure, by predicting the distribution information about the prosodic features which does not necessarily conform to the standard normal distribution, the prosodic change can be included in the mean value and the variance of the predicted distribution information so that the corresponding prosody can be determined by predicting the mean value and the variance, and in thus way, excessive smoothing in prosodic prediction is avoided. Compared with the standard normal distribution, the predicted distribution information in this way is more complex and the ability of prosodic modeling is increased to obtain diverse prosodic changes.

In one embodiment, as shown in FIGS. 2a and 2b, the speech synthesis model comprises the text encoder and the prosodic predictor, and accordingly, by the speech synthesis model, the distribution information about prosodic features of each phoneme in the text to be processed is predicted according to the linguistic features of the text to be processed, comprising:
extracting linguistic features of the text to be processed by the text encoder;
predicting, by the prosodic predictor and according to linguistic features of the text to be processed, distribution information about prosodic features of each phoneme in the text to be processed.

Specifically, after the text to be processed is input into the speech synthesis model, the text encoder in the speech synthesis model may extract linguistic features of the text to be processed and input the linguistic features of the text to be processed into the prosodic predictor. The prosodic predictor may predict the distribution information about prosodic features of each phoneme in the text to be processed on the basis of the linguistic features of the text to be processed.

The linguistic features of the text to be processed is used to represent linguistic information and is an intermediate state of the output of the neural network. The linguistic features include a high dimensional feature vector for each phoneme in the text to be processed, the high dimensional feature vector representing a feature of each phoneme. For example, for the text “ni hao”, the linguistic features can be exemplified as: (High-dimensional vector representation of n), (high-dimensional vector representation of i), (high-dimensional vector representation of h), (high-dimensional vector representation of ao).

It can be seen that, with the present embodiment, the distribution information about prosodic features of each phoneme in the text to be processed can be obtained by the text encoder and the prosodic predictor which are connected to each other in a simple and efficient and accurate prediction, and the distribution information conforms to a normal distribution which does not necessarily conform to a standard normal distribution, avoiding an excessive smoothness of the prosodic prediction. The distribution information predicted is more complex than that predicted by the standard normal distribution, and the prosodic modeling capability is also increased so as to obtain a diversified prosodic change.

In the above-mentioned step S106, the linguistic features of the text to be processed are adjusted on the basis of the distribution information about prosodic features of each phoneme in the text to be processed. In one embodiment, adjusting the linguistic features of the text to be processed on the basis of the distribution information about the prosodic characteristics of each phoneme in the text to be processed comprises:
predicting, based on the distribution information about the prosodic features of each phoneme in the text to be processed and the linguistic features of the text to be processed, a pronunciation duration of each phoneme in the text to be processed;
performing, according to the pronunciation duration of each phoneme in the text to be processed, length amplification on the linguistic features of the text to be processed to obtain the adjusted linguistic features of the text to be processed.

First, each phoneme in the text to be processed has a certain pronunciation duration when the text to be processed is played in the form of speech, for example, “n” in “ni hao” may have a pronunciation duration of 1 millisecond. Thus, the pronunciation duration of each phoneme in the text to be processed is first predicted here on the basis of the distribution information about prosodic features of each phoneme in the text to be processed and the linguistic features of the text to be processed. Pronunciation duration is one of the prosodic features.

Since the prosodic information also determines the phoneme pronunciation duration, in addition to the linguistic features, the distribution information about prosodic features of each phoneme in the text to be processed is used as a condition for predicting the phoneme pronunciation duration, thereby generating a more stable natural phoneme pronunciation duration.

Then, according to the pronunciation duration of each phoneme in the text to be processed, the length of the linguistic features of the text to be processed is amplified to obtain the adjusted linguistic features of the text to be processed. For example, the linguistic features of the text to be processed are: (high-dimensional vector representation of n), (high-dimensional vector representation of i), (high-dimensional vector representation of h) and (high-dimensional vector representation of ao), wherein phoneme n is pronounced for 1 ms, phoneme i for 2 ms, phoneme h for 3 ms and phoneme ao for 4 ms, then length on the high-dimensional vector of each phoneme is amplified on the basis of the pronunciation duration, and the adjusted linguistic features are obtained as follows: (high-dimensional vector representation of n), (high-dimensional vector representation of i), (high-dimensional vector representation of i), (high-dimensional vector representation of h), (high-dimensional vector representation of h), (high-dimensional vector representation of h), (high-dimensional vector representation of ao), (high-dimensional vector representation of ao), (high-dimensional vector representation of ao), and (high-dimensional vector representation of ao). In a simple manner, the length amplification of the linguistic features of the text to be processed can be understood as duplicating the linguistic features corresponding to the phonemes according to the pronunciation duration of each phoneme in the text to be processed.

It can be seen that with the present embodiment, in addition to dependency on the linguistic features of the text to be processed, the pronunciation duration time of each phoneme in the text to be processed is predicted on the basis of the distribution information about the prosodic characteristics of each phoneme in the text to be processed, so that a more stable and natural pronunciation duration time of the phoneme can be generated. Then, according to the pronunciation duration of each phoneme in the text to be processed, the length of the linguistic features of the text to be processed is amplified to obtain the adjusted linguistic features of the text to be processed, so as to achieve the effect of optimizing the linguistic features of the text to be processed, and thus high-quality speech data can be obtained on the basis of the adjusted linguistic features.

It can be seen from FIGS. 2a and 2b that the speech synthesis model comprises the duration predictor, and on this basis, on the basis of the distribution information about prosodic features of each phoneme in the text to be processed and the linguistic features of the text to be processed, the pronunciation duration of each phoneme in the text to be processed is predicted, comprising:
performing a re-parameterization processing on the distribution information about the prosodic features of each phoneme in the text to be processed to obtain a prosodic latent variable at a phoneme level corresponding to the text to be processed;
predicting, by the duration predictor and according to the prosodic latent variable at the phoneme level corresponding to the text to be processed and linguistic features of the text to be processed, a pronunciation duration of each phoneme in the text to be processed.

Specifically, within the prosodic predictor, the prosodic predictor can perform the re-parametrization processing on the distribution information about prosodic features of each phoneme in the text to be processed so as to obtain the prosodic implicit variable at a phoneme level corresponding to the text to be processed. The prosodic predictor can realize a process of re-parameterization by any means, and the re-parameterization is an algorithm for obtaining an implicit variable by sampling from the distribution information, and can be simply understood as a process of combining the distribution information (namely, a mean vector and a variance direction) of the prosodic features of each phoneme in the text to be processed into a vector so as to obtain the prosodic implicit variable of each phoneme in the text to be processed, and the vector is the prosodic implicit variable. In this embodiment, when the re-parameterization operation is performed, the input parameters are the distribution information about prosodic features of each phoneme in the text to be processed, and the output is the prosodic latent variable of each phoneme in the text to be processed. Since the prosodic latent variable of each phoneme in the text to be processed is obtained, for example, for the text “ni hao”, (the prosodic latent variable of n, the prosodic latent variable of i, the prosodic latent variable of h, the prosodic latent variable of ao) is obtained. Thus, the prosodic latent variable of each phoneme in the text to be processed may also be referred to as the prosodic latent variable at a phoneme level corresponding to the text to be processed.

Then, a prosodic latent variable at a phoneme level corresponding to the text to be processed and linguistic features of the text to be processed are input to the duration predictor, and the duration predictor predicts and outputs a pronunciation duration of each phoneme in the text to be processed.

Since the prosodic information also determines the phoneme pronunciation duration, in addition to the linguistic features of the text to be processed output by the text encoder, the prosodic latent variable at a phoneme level corresponding to the text to be processed is also used as a condition of the duration predictor, i.e., \hat{d}= [symbol] (z,c′)∈ [symbol] , wherein [symbol] refers to the duration predictor, c′ refers to the linguistic features of the text to be processed output by the text encoder Z refers to the prosodic latent variable at a phoneme level corresponding to the text to be processed. With this, a more stable natural phoneme pronunciation duration can be generated.

In one embodiment, the above-mentioned process of performing length amplification on the linguistic features of the text to be processed according to the pronunciation duration of each phoneme in the text to be processed to obtain the adjusted linguistic features of the text to be processed can be implemented in a duration predictor in the speech synthesis model.

It can be seen that, with the present embodiment, in predicting the pronunciation duration of each phoneme in the text to be processed, in addition to the linguistic features of the text to be processed output by the text encoder, the prosodic latent variable at a phoneme level corresponding to the text to be processed is used as a condition for the duration predictor, thereby generating a more stable natural phoneme pronunciation duration.

In the above-mentioned step S108, according to the adjusted linguistic features of the text to be processed, speech data corresponding to the text to be processed is generated. It can be seen from FIGS. 2a and 2b that the speech synthesis model comprises the acoustic encoder and the waveform decoder, and on the basis of this, according to the adjusted linguistic features of the text to be processed, the speech data corresponding to the text to be processed is generated, comprising:
performing, by the acoustic encoder, acoustic encoding on the adjusted linguistic features of the text to be processed to obtain an intermediate representation corresponding to the text to be processed;
decoding, by the waveform decoder, the intermediate representation to obtain speech data corresponding to the text to be processed.

Specifically, the adjusted linguistic features of the text to be processed is input to the acoustic encoder, and the acoustic encoder comprises a Convolutional Neural Networks (Dilated CNN), through which the adjusted linguistic features is acoustically encoded to obtain an intermediate representation corresponding to the text to be processed.

Then, the intermediate representation is input to the waveform decoder, through which the intermediate representation is decoded and the waveform obtained after decoding is subjected to encoding processing by the vocoder to obtain speech data corresponding to the text to be processed.

It can be seen that with the present embodiment, it is possible to first perform the acoustic encoding on the adjusted linguistic features of the text to be processed via the acoustic encoder to obtain the intermediate representation corresponding to the text to be processed, and then perform decoding on the intermediate representation via a waveform decoder to obtain speech data corresponding to the text to be processed to efficiently and quickly obtain high-quality and highly expressive speech data on the basis of the adjusted linguistic features.

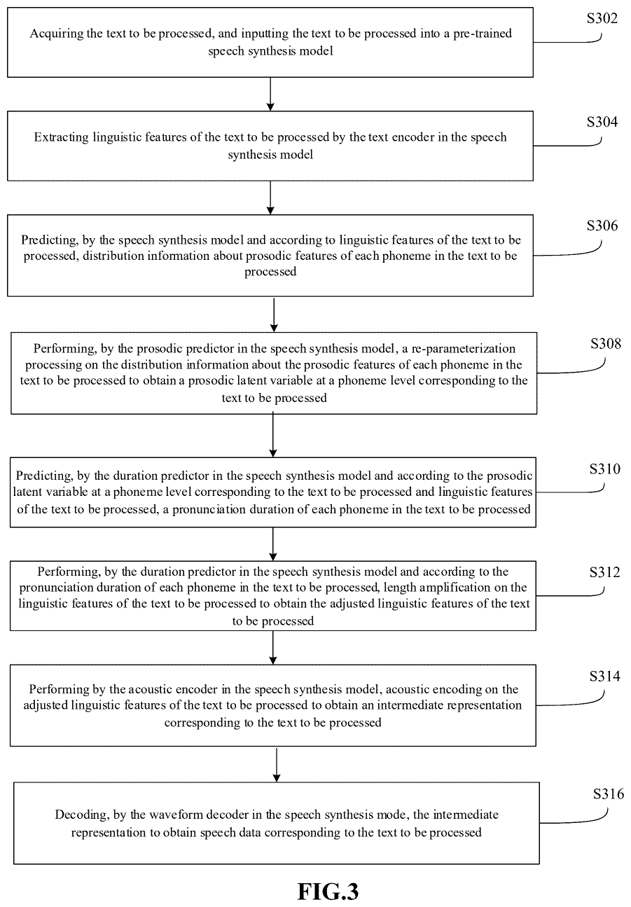

FIG. 3 illustrates a schematic flow diagram of a speech synthesis method according to another embodiment of the present disclosure. As shown in FIG. 3, the flow comprises:
Step S302, acquiring the text to be processed, and inputting the text to be processed into a pre-trained speech synthesis model;
Step S304, by the text encoder in the speech synthesis model, extracting linguistic features of the text to be processed;
Step S306, predicting, by the speech synthesis model and according to linguistic features of the text to be processed, distribution information about prosodic features of each phoneme in the text to be processed; no longer assuming that the distribution information necessarily conforms to the standard normal distribution;
Step S308, by the prosodic predictor in the speech synthesis model, performing a re-parameterization processing on the distribution information about the prosodic features of each phoneme in the text to be processed to obtain a prosodic latent variable at a phoneme level corresponding to the text to be processed;
Step S310, by the duration predictor in the speech synthesis model, predicting a pronunciation duration of each phoneme in the text to be processed according to the prosodic latent variable at a phoneme level corresponding to the text to be processed and linguistic features of the text to be processed;
Step S312, by the duration predictor in the speech synthesis model, performing, according to the pronunciation duration of each phoneme in the text to be processed, length amplification on the linguistic features of the text to be processed to obtain the adjusted linguistic features of the text to be processed;
Step S314, by the acoustic encoder in the speech synthesis model, performing acoustic encoding on the adjusted linguistic features of the text to be processed to obtain an intermediate representation corresponding to the text to be processed;

In step S316, by the waveform decoder in the speech synthesis mode, decoding the intermediate representation to obtain speech data corresponding to the text to be processed.

Reference may be made to the foregoing description regarding the specific process of FIG. 3 and would not be repeated here. The training process of the speech synthesis model is described in detail below.

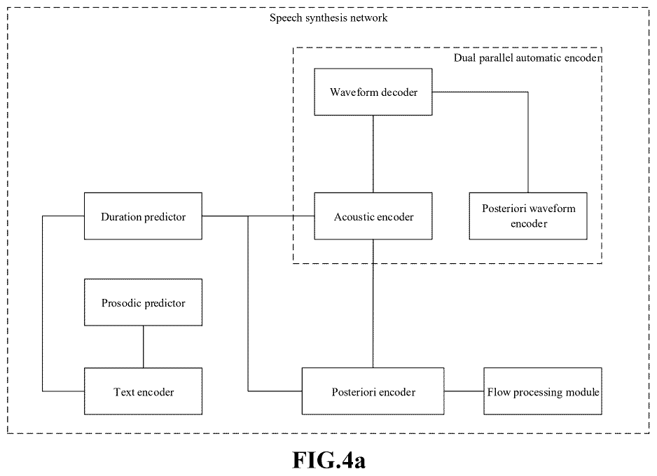

The speech synthesis model in this embodiment is obtained by training a speech synthesis network. FIG. 4a illustrates a structure diagram of a speech synthesis network according to an embodiment of the present disclosure. As shown in FIG. 4a, the network comprises: the text encoder, the prosodic predictor, the duration predictor, the posteriori encoder, the acoustic encoder, the posteriori waveform encoder, the waveform decoder and the stream processing module, wherein the text encoder is respectively connected to the prosodic predictor and the duration predictor, and the duration predictor is respectively connected to the acoustic encoder and the posteriori encoder, and the posteriori encoder is further connected to the acoustic encoder, and the waveform decoder is respectively connected to the acoustic encoder and the posteriori waveform encoder, and the stream processing module is connected to the posteriori encoder.

FIG. 4b illustrates a schematic diagram of the training principle of the speech synthesis network corresponding to FIG. 4a. As shown in FIG. 4b, the training principle of the speech synthesis network is:
1. inputting the sample text and a linear sonogram of sample speech data corresponding to the sample text into a speech synthesis network, and a text encoder extracting linguistic features c′ of the sample text and respectively transmitting same to a prosody predictor and a duration predictor.
2. the prosodic prediction unit in the prosodic predictor predicting the distribution information about prosodic features of each phoneme in the sample text on the basis of the linguistic features c′ of the sample text output by the text encoder; μₚₚ representing a mean vector in the distribution information, and Opp representing a variance vector in the distribution information.
3. the amplification unit in the duration predictor amplifying the linguistic features of the sample text according to the linguistic features c′ of the sample text output by the text encoder and the pronunciation duration of each phoneme in the sample speech data corresponding to the sample text (namely, the real pronunciation duration), adjusting the linguistic features of the sample text to obtain an adjusted linguistic features c, and outputting the adjusted linguistic features c to the acoustic encoder and the posterior encoder.
4. the linear sonogram x being input to a posteriori encoder, and a posteriori encoding unit in the posteriori encoder generating an approximate posterior distribution of prosodic features for each phoneme in the sample text on the basis of the linear sonogram x and the adjusted linguistic features c, μ_{Ø} representing a mean vector in the approximate posterior distribution, and σ_{Ø} representing a variance vector in the approximate posterior distribution; the re-parametrization unit in the posteriori encoder reparametrizing a prosodic latent variable z′ at a phoneme level of the sample text on the basis of the approximate posterior distribution and outputting the prosodic latent variable z′ to the duration predictor and the acoustic encoder, respectively.
5. the duration prediction unit in the duration predictor predicting and obtaining a pronunciation duration d of each phoneme in the sample text according to the linguistic features c′ and the prosodic latent variable z′ output by the text encoder, and the predicted pronunciation duration d training the duration prediction unit of the duration predictor in combination with the pronunciation duration (namely, a real pronunciation duration) of each phoneme in the sample speech data corresponding to the sample text.
6. the acoustic encoder generating a first intermediate representation [symbol] of the sample text based on the prosodic latent variable z′ and the adjusted linguistic features c.
7. the posteriori waveform encoder generating a second intermediate representation ir of the sample text from the linear sonogram.
8. the first intermediate representation [symbol] and the second intermediate representation ir being input to a waveform decoder and decoded, respectively, resulting in a first waveform and a second waveform.
9. the prosodic latent variable z′ being input to a stream processing module which normalizes the prosodic latent variable z′ to obtain a prior distribution of prosodic features for each phoneme in the sample text.
10. the parameters of the speech synthesis network being inversely adjusted according to the distribution information about prosodic features of each phoneme in the sample text output by the first waveform, the second waveform, the approximate posterior distribution, the prior distribution and the prosodic predictor. Specifically, determining a marginal log-likelihood lower bound of the fit distribution of the linear sonogram according to the approximate posterior distribution, the prior distribution and the likelihood function of the linear sonogram, determining a similarity between the first waveform and the second waveform, determining a divergence between the approximate posterior distribution and the distribution information about prosodic features of each phoneme in the sample text output by the prosodic predictor, and feedback adjusting the parameters of the speech synthesis network with a goal of maximizing the similarity, minimizing the divergence and maximizing the marginal log-likelihood lower bound.
11. after the parameter adjustment of the speech synthesis network being completed, the posterior encoder, the posterior waveform encoder and the stream processing module in the speech synthesis network being removed, the re-parameterization unit being added to the prosodic predictor so as to obtain the speech synthesis model.

As can be seen from FIGS. 4a and 4b, the acoustic encoder, the posteriori waveform encoder and the waveform decoder constitute a dual parallel automatic encoder (DPA), in which two parallel encoders, i.e., the acoustic encoder and the posteriori waveform encoder, generate an intermediate representation and optimize same using a dual training method. The acoustic encoder generates a predicted intermediate representation [symbol] , and the posteriori waveform encoder converts the linear sonogram into the intermediate representation ir. During training, the waveform decoder acts as a decoder for the DPA and generates waveforms from [symbol] and ir. Furthermore, for dual training, the mean absolute error (MAE) between ir and [symbol] can be calculated, ir and [symbol] being close to each other and thus [symbol] being normalized by ir.

By setting DPA, search space of waveform modeling can be reduced, and the problem of poor modeling ability of high-frequency information can be solved.

In one example, the same challenge training method as HiFi-GAN is used to increase the resolution of the synthesized speech. Two discriminators are used for joint confrontation training, MPD and MBD in HiFi-GAN. MBD uses a pseudo-quadrature mirror filter bank (Pseudo-QMF) to divide the waveform into N subbands. The N full-band subbands are sent to the N+1 scale discriminators in MelGAN, respectively. By applying different discriminators in different frequency bands of synthesized audio, MBD can significantly improve the quality of the high-frequency part, enabling the speech synthesis model to generate high-fidelity audio at a high sampling rate.

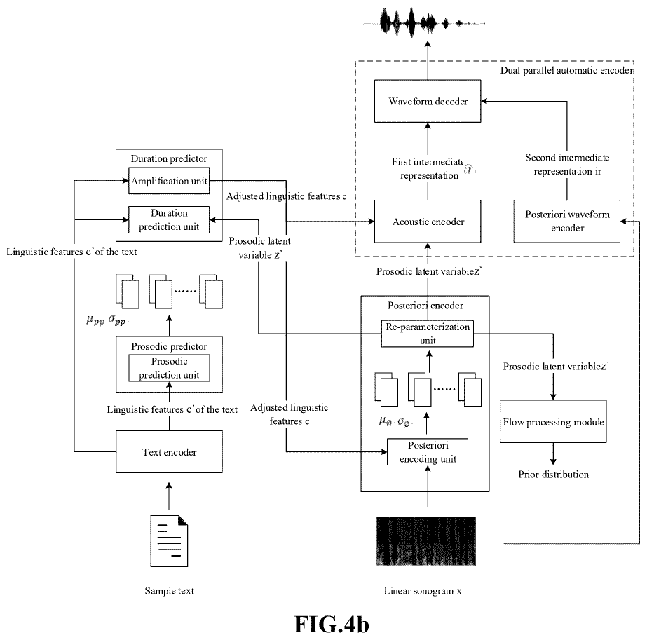

On the basis of the above principles, FIG. 5 illustrates a schematic diagram of the training flow for a speech synthesis model according to an embodiment of the present disclosure. As shown in FIG. 5, in one embodiment, the speech synthesis model is trained by the following steps:
Step S502, acquiring sample data and inputting the sample data into a speech synthesis network, wherein the sample data comprises a sample text and a linear sonogram of sample speech data corresponding to the sample text;
Step S504, generating, by the speech synthesis network and based on the sample data, approximate posterior distribution of prosodic features of each phoneme in the sample text; the approximate posterior distribution does not necessarily conform to the standard normal distribution;

In step S506, performing, based on the approximate posteriori distribution, feedback regulation on parameters of the speech synthesis network to generate the speech synthesis model.

Specifically, sample data for model training is first acquired, the sample data including sample text and a linear sonogram of sample speech data corresponding to the sample text. The sample speech data corresponding to the sample text can be considered as standard speech data of the sample text, and the linear sonogram of the sample speech data can be obtained by performing Short-time Fourier Transform (STFT) on the sample speech data. The sample text and the linear sonogram of the sample speech data corresponding to the sample text are input into a pre-established speech synthesis network.

The approximate posterior distribution of prosodic features of each phoneme in the sample text is generated by the speech synthesis network and based on the sample data. From the foregoing description of the principles, the approximate posteriori distribution is output by the posteriori encoder. Since the whole speech generation network is equivalent to a conditional variational self-encoder, the distribution information (namely, the mean vector and the variance vector) of the prosodic features of each phoneme in the sample text output by the posteriori encoder is referred to as the approximate posterior distribution. The approximate posterior distribution does not necessarily follow the standard normal distribution.

Finally, feedback regulation is performed on the parameters of the speech synthesis network on the basis of the approximate posterior distribution, and after the regulation of the parameters of the speech synthesis network is completed, the posterior encoder, the posterior waveform encoder and the stream processing module in the speech synthesis network are removed, and the re-parameterization unit is added to the prosodic predictor so as to obtain the speech synthesis model. The feedback regulation of the parameters of the speech synthesis network as described throughout this embodiment refers to feedback regulation of parameters of the various modules, encoders, decoders and internal networks and units of the speech synthesis network.

It can be seen that with the present embodiment, when the speech synthesis network is trained, the approximate posterior distribution of the prosodic features of each phoneme in the sample text can be generated based on the sample data, and the approximate posterior distribution does not necessarily conform to a standard normal distribution, on the basis of which, feedback regulation of parameters of the speech synthesis network is performed to generate a speech synthesis model. Compared with assuming the prosodic distribution as the standard normal distribution in the prior art, assuming the approximate posterior distribution does not necessarily conform to the standard normal distribution not only alleviates the problem of excessive smoothing in prosodic prediction, but also increase the prosodic modeling capability. More diverse prosodic changes can be obtained, improving the diversity and stability of the prosody, thereby improving the expressiveness of the synthesized speech data and improving the quality of the synthesized speech data.

As can be seen from the foregoing introduction of principles, the speech synthesis network comprises the posteriori encoder, and in one embodiment, generating, by the speech synthesis network and based on the sample data, the approximate posterior distribution of the prosodic features of each phoneme in the sample text comprises:
generating, by the posteriori encoder and based on t the linear sonogram and linguistic features of the sample text, prosodic features at a phoneme level of the sample text;
performing, by the posteriori encoder, linear transformation to the prosodic features at a phoneme level of the sample text to obtain approximate posterior distribution of the prosodic features of each phoneme in the sample text.

Specifically, the linear sonogram and the linguistic features of the sample text are input to the posteriori encoder, wherein the linguistic features input to the posteriori encoder are adjusted linguistic features obtained after the amplification unit in a duration predictor amplifies the linguistic features of the sample text output by the text encoder. The posteriori encoding unit in the posteriori encoder generates prosodic features at a phoneme level of the sample text on the basis of the linear spectrogram and the adjusted linguistic features, and performs linear transformation on the prosodic features at a phoneme level of the sample text to obtain the approximate posterior distribution of the prosodic features of each phoneme in the sample text.

It can be seen that with the present embodiment, it is possible to generate prosodic features at a phoneme level of a sample text via a posteriori encoder on the basis of the linear spectrogram and the linguistic features of the sample text, and then perform linear transformation on the prosodic features at a phoneme level of the sample text to obtain an approximate posterior distribution of the prosodic features of each phoneme in the sample text. This manner has the advantage that the obtained approximate posterior distribution has a high accuracy.

In one embodiment, generating, by the posteriori encoder and based on the linear sonogram and the linguistic features of the sample text, the prosodic features at the phoneme level of the sample text comprises:
generating, by the posteriori encoder and based on the linear sonogram and linguistic features of the sample text, first prosodic features at a frame level of the sample text;
performing, by the posteriori encoder, matrix conversion on the first prosodic features at a frame level of the sample text to obtain the prosodic features at a phoneme level of the sample text.

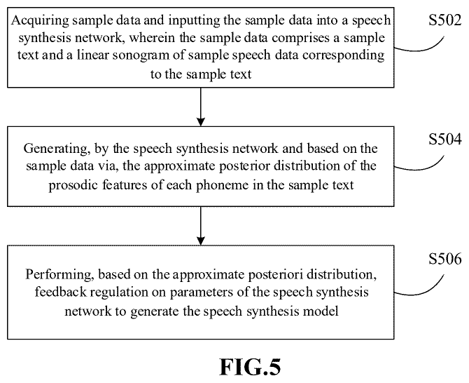

FIG. 6 illustrates a schematic diagram of the principle of a posteriori encoder and an acoustic encoder according to an embodiment of the present disclosure. As shown in FIG. 6, the posteriori encoder includes the posteriori encoding unit and the re-parameterization unit, wherein the posteriori encoding unit includes the dilation convolution neural network, a feature transformation unit, and a linear network.

After the adjusted linguistic features of the sample text and the linear sonogram are input into the posterior encoding unit, the dilation convolution neural network can generate the prosodic features at a frame level of the sample text, namely, the first prosodic features at a frame level, according to the adjusted linguistic features of the sample text and the linear sonogram. Then, the first prosodic features at a frame level of the sample text are output to the feature conversion unit, and the feature conversion unit can perform matrix conversion on the first prosodic features at a frame level of the sample text to obtain the prosodic features at a phoneme level of the sample text. The specific principle of the feature conversion unit can be represented by the following formula:

PFₚₕₒₙₑ=diag(s)*A*PF_{frame}

Prosody at a phoneme level is modeled due to its appropriate granularity and stability. Since the input linear sonogram is frame-level, the prosodic features at a frame level are converted to prosodic features at a phoneme level. In the formula, PFₚₕₒₙₑ∈ [symbol] and PF_{frame}∈ [symbol] respectively represent the prosodic features at a phoneme level of the sample text and the prosodic features at a frame level of the sample text, A∈ [symbol] represents a hard alignment matrix, and represent the corresponding relationship between the linguistic features and the linear sonogram, and are obtained by calculating the true pronunciation duration of each phoneme in the sample text. s∈ [symbol] represents the reciprocal

$$( {s}_{i} = 1 / {\sum }_{j = 1}^{{T}_{f}} {a}_{ij} )$$

of the true pronunciation duration of each phoneme in the sample text. Tₚ is the length of time of PFₚₕₒₙₑ, T_{f} is the length of time of PF_{frame}, d is the vector dimension of PFₚₕₒₙₑ and PF_{frame}, [symbol] is a real number. aᵢⱼ is the ith row jth column of the hard alignment matrix.

The prosodic features at a phoneme level of the sample text can be understood as the prosodic features of each phoneme in the sample text, for example, if the sample text is “ni hao”, the prosodic features at a phoneme level thereof can be represented as: (feature vector of the prosodic features of n, feature vector of the prosodic features of i, feature vector of the prosodic features of h, feature vector of the prosodic features of ao),

Then, the feature conversion unit outputs the prosodic features at a phoneme level of the sample text to the linear network, and the linear network performs linear transformation on the prosodic features at a phoneme level of the sample text to obtain the approximate posterior distribution of the prosodic features of each phoneme in the sample text. The approximate posterior distribution of the prosodic features of each phoneme in the sample text is the distribution information (namely, the mean vector and the variance vector) of the prosodic features of each phoneme in the sample text. Since the whole speech generation network is equivalent to a conditional variation self-encoder, the distribution information (namely, the mean vector and the variance vector) of the prosodic features of each phoneme in the sample text output by the posterior encoder is referred to as the approximate posterior distribution. This approximate posterior distribution does not necessarily follow the standard normal distribution.

It can be seen that, with the present embodiment, the first prosodic features at a frame level of the sample text can be generated according to the linear spectrogram and the linguistic features of the sample text by the posteriori encoder, and the prosodic features at a phoneme level of the sample text can be obtained by performing matrix conversion on the first prosodic features at a frame level of the sample text by the posteriori encoder, so that the prosodic features at a phoneme level of the sample text can be accurately converted from the first prosodic features at a frame level of the sample text by the matrix conversion. Prosody at a phoneme level has appropriate granularity and stability which can improve the quality of the synthesized speech data.

In one embodiment, performing, based on the approximate posteriori distribution, the feedback regulation on the parameters of the speech synthesis network to generate the speech synthesis model comprises:
performing the re-parametrization processing on the approximate posterior distribution to obtain a prosodic latent variable at a phoneme level corresponding to the sample text;
performing based on the prosodic latent variable and the approximate posterior distribution, feedback regulation on parameters of the speech synthesis network to generate the speech synthesis model.

First, the approximate posterior distribution is re-parameterized to obtain the prosodic implicit variable corresponding to the phoneme level of the sample text. FIG. 6 illustrates a schematic diagram of the principle of a posteriori encoder and an acoustic encoder according to an embodiment of the present disclosure. As shown in FIG. 6, the posteriori encoder comprises the posteriori encoding unit and the re-parametrization unit, wherein the posteriori encoding unit outputs the approximate posterior distribution to the re-parametrization unit, and the re-parametrization unit reparametrizes the approximate posterior distribution to obtain a prosodic implicit variable at a phoneme level corresponding to the sample text. The re-parameterization can be simply understood as a process of combining the distribution information (i.e., approximate posterior distribution, including the mean vector and the variance direction) of the prosodic features of each phoneme in the sample text into one vector so as to obtain the prosodic latent variable of each phoneme in the sample text, and the one vector is the prosodic latent variable. Since what is obtained is the prosodic latent variable for each phoneme in the sample text, for example, (the prosodic latent variable of n, the prosodic latent variable of i, the prosodic latent variable of h, and the prosodic latent variable of ao) for the text “ni hao”, the prosodic latent variable for each phoneme in the sample text may also be referred to as the prosodic latent variable at a phoneme level corresponding to the sample text.

Then, on the basis of the prosodic implicit variable and the approximate posterior distribution, the feedback regulation of parameters of the speech synthesis network is performed to generate the speech synthesis model.

It can be seen that, by the present embodiment, it is possible to re-parameterize the approximate posterior distribution so as to obtain a prosodic implicit variable at a phoneme level corresponding to the sample text, accurately perform feedback regulation of parameters of the speech synthesis network on the basis of the prosodic implicit variable and the approximate posterior distribution, generate the speech synthesis model, and improve the speech synthesis quality of the speech synthesis model by the prosodic implicit variable.

According to the above introduction of the structure and training principle of the speech synthesis network, it can be seen that the speech synthesis network comprises the prosodic predictor. Accordingly, performing, based on the prosodic latent variable and the approximate posterior distribution, feedback regulation on parameters of the speech synthesis network to generate the speech synthesis model comprises:
determining, by the prosodic predictor, distribution information about prosodic features of each phoneme in the sample text;
performing, based on the prosodic latent variable, the approximate posterior distribution and the distribution information about prosodic features of each phoneme in the sample text, feedback regulation on the parameters of the speech synthesis network to generate the speech synthesis model.

Specifically, after the sample text is acquired, the sample text is input into the text encoder to obtain linguistic features of the sample text. The prosodic prediction unit in the prosodic predictor predicts distribution information about prosodic features of each phoneme in the sample text on the basis of the linguistic features of the sample text output by the text encoder; and the distribution information may be distributed in an arbitrary manner since the prosodic predictor is not trained yet. The trained prosodic predictor may generate distribution information about prosodic features of each phoneme in the text that does not necessarily conform to a standard normal distribution.

Next, parameters for adjusting the speech synthesis network are fed back on the basis of the prosodic implicit variable, the approximate posterior distribution and the distribution information about prosodic features of each phoneme in the sample text to generate a speech synthesis model.

It can be seen that, with the present embodiment, feedback regulation of parameters of the speech synthesis network can be performed based on the prosodic latent variable, the approximate posterior distribution and the distribution information about prosodic features of each phoneme in the sample text so as to generate the speech synthesis model. The prosodic latent variable, the approximate posterior distribution and the distribution information about prosodic features of each phoneme in the sample text cooperate with each other, improving the speech synthesis quality of the speech synthesis model and the expressiveness of the speech data.

According to the above introduction of the structure and training principle of the speech synthesis network, it can be seen that the speech synthesis network comprises a posteriori waveform encoder. Accordingly, performing, based on the prosodic latent variable, the approximate posterior distribution and the distribution information about prosodic features of each phoneme in the sample text, feedback regulation on parameters of the speech synthesis network to generate the speech synthesis model comprises:
generating, according to the prosodic latent variable, a first intermediate representation corresponding to the sample text and prior distribution of prosodic features of each phoneme in the sample text;
encoding, by the posterior waveform encoder, the linear sonogram to obtain a second intermediate representation corresponding to the sample text;
performing, according to the first intermediate representation, the second intermediate representation, the approximate posterior distribution, the distribution information about prosodic features of each phoneme in the sample text and the prior distribution, feedback regulation on parameters of the speech synthesis network to generate the speech synthesis model.

In particular, the first intermediate representation corresponding to the sample text and the prior distribution of prosodic features of each phoneme in the sample text are first generated according to prosodic latent variables, and the specific generation process is described later. The linear sonogram in the sample data is then input to the posteriori waveform encoder that is capable of encoding the linear sonogram to obtain the second intermediate representation of the sample text. Finally, feedback regulation of parameters of speech synthesis network is performed according to the first intermediate representation, the second intermediate representation, the approximate posterior distribution, the distribution information about prosodic features of each phoneme in the sample text and the prior distribution to generate the speech synthesis model.

It will be appreciated that the speech synthesis of the speech synthesis network works better when the first intermediate representation and the second intermediate representation are close to each other, and posterior distribution and the distribution information about prosodic features of each phoneme in the sample text are approximated.

It can be seen that, with the present embodiment, according to the first intermediate representation, the second intermediate representation, the approximate posterior distribution, the distribution information about prosodic features of each phoneme in the sample text and the prior distribution, the feedback regulation of parameters of the speech synthesis network is performed to generate the speech synthesis model, and the effect of comprehensively training the speech synthesis network in combination with various factors and improving the speech synthesis quality of the speech synthesis model can be achieved.

According to the above description of the structure and training principle of the speech synthesis network, it can be seen that the speech synthesis network comprises the acoustic encoder. Accordingly, generating, according to the prosodic latent variable, the first intermediate representation corresponding to the sample text comprises:
converting, by the acoustic encoder, a prosodic latent variable at a phoneme level corresponding to the sample text to obtain second prosodic features at a frame level of the sample text;
performing, by the acoustic encoder and according to the second prosodic features at the frame level of the sample text, acoustic encoding on linguistic features of the sample text to obtain the first intermediate representation corresponding to the sample text.

According to the training principle of the previous speech synthesis network, it can be seen that the amplification unit in the duration predictor amplifies the linguistic features of the sample text according to the linguistic features of the sample text output by the text encoder and the pronunciation duration of each phoneme in the sample speech data corresponding to the sample text (namely, the real pronunciation duration), adjusts the linguistic features of the sample text to obtain the adjusted linguistic features, and outputs the adjusted linguistic features to the acoustic encoder. The acoustic encoder generates a first intermediate representation of the sample text based on the prosodic latent variables and the adjusted linguistic features.

FIG. 6 illustrates a schematic diagram of the principle of a posteriori encoder and an acoustic encoder according to an embodiment of the present disclosure. As shown in FIG. 6, the acoustic encoder comprises the conversion unit and the expanded convolution neural network, wherein the input of the conversion unit is a prosodic latent variable, and the conversion unit converts the prosodic latent variable at a phoneme level corresponding to the sample text to obtain prosodic features at a frame level of the sample text, namely, second prosodic features.

In one embodiment, the conversion unit may convert the prosodic latent variable at a phoneme level corresponding to the sample text to obtain the second prosodic features at a frame level of the sample text by the following formula:

[symbol]

_{frame}=A^{T}*z′

In the formula, z′ is the prosodic latent variable at a phoneme level corresponding to the sample text, and represents the prosody at a phoneme level of the speech, and [symbol] _{frame} represents the second prosodic features at a frame level of the sample text, and A^{T} is a transpose matrix of the above matrix. By converting the prosodic latent variable at a phoneme level corresponding to the sample text into second prosodic features at a frame level, the length of the prosodic features can be made to match the length of the adjusted linguistic features.

The conversion unit outputs the second prosodic features at a frame level of the sample text to the dilation convolution neural network, and the input of the dilation convolution neural network also has the adjusted linguistic features of the sample text, and the dilation convolution neural network performs acoustic encoding on the adjusted linguistic features of the sample text according to the second prosodic features at a frame level of the sample text to obtain a first intermediate representation corresponding to the sample text. The first intermediate representation is output to the waveform decoder.

It can be seen that with the present embodiment, the second prosodic features at a frame level of the sample text can be obtained by converting, by the acoustic encoder, the prosodic latent variable at a phoneme level corresponding to the sample text so that the length of the prosodic features matches the length of the adjusted linguistic features, and the first intermediate representation corresponding to the sample text can be obtained by acoustically encoding the linguistic features of the sample text according to the second prosodic features at a frame level of the sample text so as to output the accurate first intermediate representation.

It can be seen from the above description of the structure and the training principle of the speech synthesis network, the speech synthesis network comprises a stream processing module. Accordingly, generating, based on the prosodic latent variable, the prior distribution of the prosodic features of each phoneme in the sample text comprises:
performing normalized flow processing on the prosodic implicit variable to obtain the prior distribution of prosodic features of each phoneme in the sample text.

Specifically, the prosodic latent variable is input to the stream processing module, and the stream processing module performs normalization stream processing on the prosodic latent variable to obtain the prior distribution of the prosodic features of each phoneme in the sample text. In a specific embodiment, since it is assumed that the above-mentioned approximate posteriori distribution is not necessarily a standard normal distribution, i.e., q_{Ø}(z′|x,c)= [symbol] (z′;μ_{Ø}(x,c),σ_{Ø}(x,c)), where z′ represents the prosodic latent variable, x represents any one of the data points in the linear spectrogram, C represents the adjusted linguistic features of the sample text, μ_{Ø}(x,c) represents the mean vector in the approximate a posteriori distribution, σ_{Ø}(x,c) represents the variance vector in the approximate a posteriori distribution, req_{Ø}(z′|x,c) presents the approximate a posteriori distribution. To convert the approximate posterior distribution to the standard normal distribution, an unconditional normalization process is applied as follows:

$${p}_{ψ} ( {z}^{′} ) = 𝒩 ( {f}_{ψ} ( {z}^{′} ) ; 0 , I ) \vert det \frac{\partial {f}_{ψ} ( {z}^{′} )}{\partial {z}^{′}} \vert$$

f_{ψ} represents parameters of a normalized flow processing module. p_{ψ}(z′) represents the priori distribution of prosodic features of each phoneme in the sample text.

It can be seen that with this embodiment, the prosodic latent variable can be normalized by the flow processing module to obtain the prior distribution of the prosodic features of each phoneme in the sample text in order to perform feedback regulation of the parameters of the speech synthesis network by the prior distribution.

Further, in one embodiment, performing, according to the first intermediate representation, the second intermediate representation, the approximate posterior distribution, the distribution information about prosodic features of each phoneme in the sample text and the prior distribution, feedback regulation on parameters of the speech synthesis network to generate the speech synthesis model comprises:
determining, according to the approximate posterior distribution, the prior distribution, and a likelihood function of the linear sonogram, a marginal log-likelihood lower bound of fit distribution of the linear sonogram;
performing, according to the first intermediate representation, the second intermediate representation, the approximate posterior distribution, the distribution information about prosodic features of each phoneme in the sample text, and the marginal log-likelihood lower bound, feedback regulation on parameters of the speech synthesis network to generate the speech synthesis model.

Firstly, determining, according to the approximate posterior distribution, the prior distribution, and a likelihood function of the linear sonogram in the sample data, a marginal log-likelihood lower bound of fit distribution of the linear sonogram, and the formula of the marginal log-likelihood lower bound of the fit distribution of the linear sonogram in the sample data is as follows:

E_{q}_{_{φ}}_{(z′|x,c)}[ log p_{θ}(x|z′,c)]−Dₖₗ(q_{φ}(z′|x,c)∥p_{ψ}(z′))

In this formula, Dₖₗ(q_{φ}(z′|x,c)∥p_{ψ}(z′)) is as follows:

Lₖₗ=Dₖₗ(q_{φ}(z′|x,c)∥p_{ψ}(z′))= [symbol] _{q}_{_{φ}}_{(z′|x,c)}[ log q_{φ}(z′|x,c)−log p_{ψ}(z′)]
q_{Ø}(z′|x,c) is the approximate posterior distribution of the adjusted linguistic features C of a given data point x in the linear spectrogram in the sample data and the sample text, and p_{θ}(x|z′,c) is a likelihood function of the sum of the prosodic implicit variables z′ and c of each phoneme in the sample text, i.e., is the likelihood function of the linear spectrogram in the sample data, and p_{ψ}(z′) is the prior distribution.

Then, the feedback regulation of parameters of the speech synthesis network is performed to generate the speech synthesis model according to the first intermediate representation, the second intermediate representation, the approximate posterior distribution, the distribution information about prosodic features of each phoneme in the sample text, and the marginal log-likelihood lower bound.

It can be seen that with the present embodiment, the parameters of the speech synthesis network can be feedback adjusted according to a plurality of phonemes, such as the first intermediate representation, the second intermediate representation, the approximate posterior distribution, the distribution information about prosodic features of each phoneme in the sample text, and the lower bound of the marginal log likelihood, so as to improve the speech synthesis quality of the generated speech synthesis model.

It can be seen from the above-mentioned description that the speech synthesis network comprises a waveform decoder, and performing, according to the first intermediate representation, the second intermediate representation, the approximate posterior distribution, the distribution information about prosodic features of each phoneme in the sample text, and the marginal log-likelihood lower bound, feedback regulation on parameters of the speech synthesis network to generate the speech synthesis model comprises:
decoding, by the waveform decoder, the first intermediate representation and the second intermediate representation respectively to obtain a first waveform and a second waveform;
performing, according to the first waveform, the second waveform, the approximate posterior distribution, the distribution information about prosodic features of each phoneme in the sample text, the marginal log-likelihood lower bound, feedback regulation on the parameters of the speech synthesis network to generate the speech synthesis model.

It can be seen that in the present embodiment, the first intermediate representation and the second intermediate representation are respectively decoded to obtain the first waveform and the second waveform, and on the basis of the first waveform and the second waveform, the approximate posterior distribution, the distribution information about prosodic features of each phoneme in the sample text, and the lower bound of the marginal log likelihood, the feedback regulation of parameters of the speech synthesis network is performed so as to improve the expressiveness of the speech data of the generated speech synthesis model.

In one embodiment, performing, according to the first waveform, the second waveform, the approximate posterior distribution, the distribution information about prosodic features of each phoneme in the sample text, the marginal log-likelihood lower bound, feedback regulation on parameters of the speech synthesis network to generate the speech synthesis model comprises:
determining a degree of similarity between the first waveform and the second waveform;
determining a divergence between the approximate posterior distribution and distribution information about prosodic features of each phoneme in the sample text;
performing, according to the degree of similarity, the divergence, the marginal log-likelihood lower bound, feedback regulation on the parameters of the speech synthesis network to generate the speech synthesis model.

Specifically, the degree of similarity between the first waveform and the second waveform may be determined by formula calculation or in a manual manner. The KL divergence between the approximate posterior distribution and the distribution information about prosodic features of each phoneme in the sample text is calculated. The distribution information about prosodic features of each phoneme in the sample text can be made close to the approximate posterior distribution by calculating the divergence, and the first waveform and the second waveform can be made close to each other by calculating the similarity. Finally, according to the similarity, divergence and marginal log-likelihood lower bound, the feedback regulation of parameters of the speech synthesis network is performed to generate the speech synthesis model.

For example, the feedback regulation of parameters of the speech synthesis network is performed to generate the speech synthesis model under the conditions of maximizing the similarity, minimizing the divergence and maximizing the marginal log-likelihood lower bound. In the process of adjusting the parameters of the speech synthesis network, it is also possible to manually listen to the similarity between the speech data corresponding to the first waveform and the second waveform and the sample speech data corresponding to the sample text, or observe the similarity between the speech data corresponding to the first waveform and the second waveform and the sample speech data corresponding to the sample text by observing a linear sonogram, or manually listen to the prosody of the speech data corresponding to the first waveform and the second waveform. When the similarity and the prosody meet the requirements, it is considered that the model training is completed.

In this embodiment, by minimizing the divergence between the approximate posterior distribution and the distribution information about prosodic features of each phoneme in the sample text, over-smoothing of the prosodic prediction by the speech synthesis model can be avoided and the diversity of the prosody predicted by the prosodic predictor can be ensured.

It can be seen that with the present embodiment, on the basis of the similarity between the first waveform and the second waveform, the divergence between the approximate posterior distribution and the distribution information about prosodic features of each phoneme in the sample text, and the marginal log-likelihood lower bound, a speech synthesis model with a higher speech synthesis quality and better speech expressivity can be obtained.

It can be seen from the foregoing that the speech synthesis network further comprises the duration predictor, and in one embodiment, the duration predictor is trained by:
predicting, by the duration predictor and based on the prosodic latent variable, a pronunciation duration of each phoneme in the sample text;
inversely adjusting, according to a pronunciation duration of each phoneme in sample speech data corresponding to the sample text and a predicted pronunciation duration, parameters of the duration predictor.

It can be seen from the above-mentioned description that the linear sonogram is input into the posteriori encoder, and the posteriori encoding unit in the posteriori encoder generates the approximate posterior distribution of the prosodic features of each phoneme in the sample text on the basis of the linear sonogram and the adjusted linguistic features, and the re-parameterization unit in the posteriori encoder obtains prosodic implicit variables at a phoneme level of the sample text on the basis of the approximate posterior distribution and outputs the prosodic implicit variables to the duration predictor respectively.

The duration prediction unit in the duration predictor predicts and obtains the pronunciation duration of each phoneme in the sample text according to the linguistic features and prosodic implicit variables output by the text encoder, and the predicted pronunciation duration can train the duration prediction unit of the duration predictor in combination with the pronunciation duration of each phoneme in the sample speech data corresponding to the sample text (namely, the real pronunciation duration).

Since the prosodic information also determines the phoneme pronunciation duration, in addition to the linguistic characteristics of the \hat{d}= [symbol] (c′, z′)∈ [symbol] sodic latent variable at a phoneme level corresponding to the sample text is used as a condition for the duration predictor, i.e., where [symbol] represents the duration predictor, and c′ is the linguistic characteristics of the sample text output by the text encoder, and z′ represents the prosodic latent variable at a phoneme level corresponding to the sample text, and \hat{d} represents the duration. In this way, a more stable and natural phoneme pronunciation duration can be generated.

It can be seen that with this embodiment, the training condition of the duration predictor includes a prosodic implicit variable in addition to the linguistic features that such the duration predictor can generate a more stable and natural phoneme pronunciation duration.

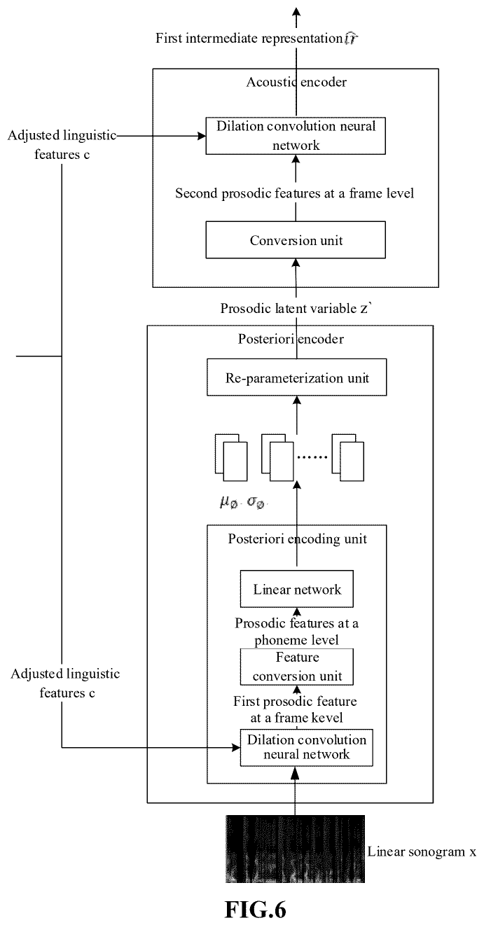

FIG. 7 illustrates a schematic diagram of a training flow of a speech synthesis model provided by another embodiment of the present disclosure. As shown in FIG. 7, the flow comprises:
Step S702, acquiring sample data of model training, inputting the sample data into a pre-established speech synthesis network, wherein the sample data comprises a sample text and a linear sonogram of sample speech data corresponding to the sample text;
Step S704, generating, by the duration predictor, adjusted linguistic features of the sample text;
Step S706, determining, by the prosodic predictor, the distribution information about prosodic features of each phoneme in the sample text;
Step S708, generating, by the posteriori encoder and based on the linear sonogram and the linguistic features of the sample text, approximate posterior distribution of the prosodic features of each phoneme in the sample text and a prosodic implicit variable at a phoneme level corresponding to the sample text;
Step S710, predicting, by the duration predictor and based on the prosodic latent variable, a pronunciation duration of each phoneme in the sample text, and inversely adjusting, according to a pronunciation duration of each phoneme in sample speech data corresponding to the sample text and a predicted pronunciation duration, parameters of the duration predictor;
Step S712, generating, by the acoustic encoder and according to the prosodic latent variable at a phoneme level corresponding to the sample text and the adjusted linguistic features of the sample text, the first intermediate representation corresponding to the sample text;
Step S714, encoding, by the posterior waveform encoder, the linear sonogram to obtain the second intermediate representation corresponding to the sample text;
Step S716, performing normalized flow processing on the prosodic implicit variable to obtain the prior distribution of prosodic features of each phoneme in the sample text;
Step S718, performing, according to the first intermediate representation, the second intermediate representation, the approximate posterior distribution, the distribution information about prosodic features of each phoneme in the sample text and the prior distribution, feedback regulation on parameters of the speech synthesis network to generate the speech synthesis model.

In summary, the embodiments of the present disclosure provide a speech synthesis model, which may also be referred to as CLONE, and can be understood as a conditional variational self-encoder, which has at least the following technical effects:
1. The speech synthesis model is an end-to-end speech synthesis system capable of generating high-quality waveforms directly from texts in parallel, solving the problem that the same phoneme has different prosody in different texts, making the same phoneme have context-consistent prosody expression in different texts, improving the expression ability of speech data, and alleviating the problem of over-smoothing prosody;
2. The prosodic distribution predicted by the prosodic predictor does not necessarily conform to the standard normal distribution, which can improve the diversity and stability of prosody;
3. The duration predictor is trained in combination with prosodic features training, making the duration predicted by the duration predictor have diversity and stability;
4. By setting the dual parallel automatic encoder DPA, the search space of waveform modeling can be reduced, and the problem of poor modeling ability of high-frequency information can be solved.

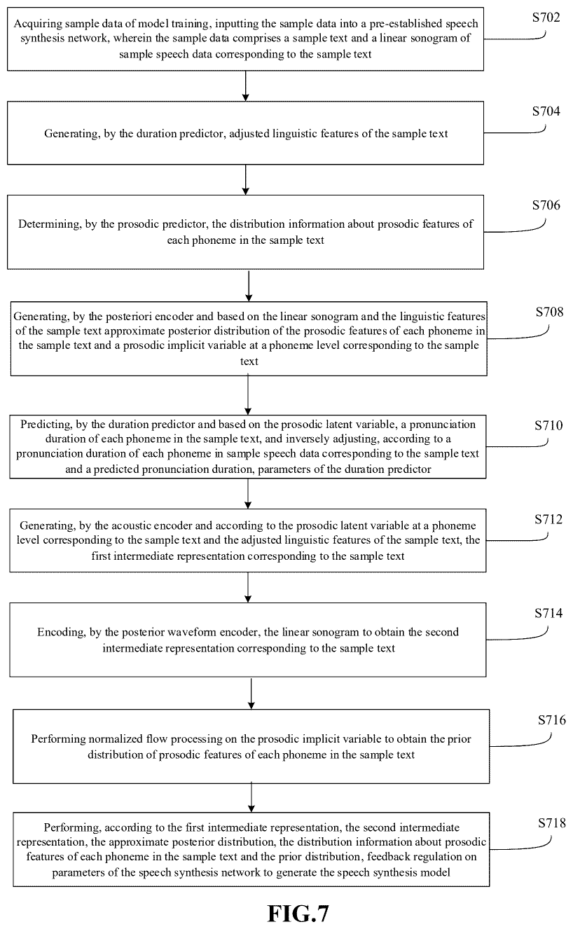

Embodiments of the present disclosure also provide a speech synthesis apparatus for implementing the above-mentioned speech synthesis method. FIG. 8 illustrates a structure diagram of a speech synthesis apparatus according to an embodiment of the present disclosure. As shown in FIG. 8, the apparatus comprises:
A text acquisition unit 81 for acquiring a text to be processed, and inputting the text to be processed into a speech synthesis model;
A distribution prediction unit 82 for predicting, by the speech synthesis model and according to linguistic features of the text to be processed, distribution information about prosodic features of each phoneme in the text to be processed;
A feature adjustment unit 83 for adjusting, based on the distribution information about the prosodic features of each phoneme in the text to be processed, linguistic features of the text to be processed;
A data generation unit 84 for generating, according to the adjusted linguistic features of the text to be processed, speech data corresponding to the text to be processed.

Optionally, the speech synthesis model comprises the text encoder and the prosodic predictor; the distribution prediction unit 82 is specifically used for:
extracting linguistic features of the text to be processed by the text encoder;
predicting, by the prosodic predictor and according to linguistic features of the text to be processed, distribution information about prosodic features of each phoneme in the text to be processed.

Optionally, the feature adjustment unit 83 is specifically used for:
predicting, based on the distribution information about the prosodic features of each phoneme in the text to be processed and the linguistic features of the text to be processed, a pronunciation duration of each phoneme in the text to be processed;
performing, according to the pronunciation duration of each phoneme in the text to be processed, length amplification on the linguistic features of the text to be processed to obtain the adjusted linguistic features of the text to be processed.

Optionally, the speech synthesis model comprises the duration predictor, and the feature adjustment unit 83 is also specifically used for:
performing a re-parameterization processing on the distribution information about the prosodic features of each phoneme in the text to be processed to obtain a prosodic latent variable at a phoneme level corresponding to the text to be processed;
predicting, by the duration predictor and according to the prosodic latent variable at the phoneme level corresponding to the text to be processed and linguistic features of the text to be processed, a pronunciation duration of each phoneme in the text to be processed.

Optionally, the speech synthesis model comprises the acoustic encoder and the waveform decoder; the data generation unit 84 is specifically used for:
performing, by the acoustic encoder, acoustic encoding on the adjusted linguistic features of the text to be processed to obtain an intermediate representation corresponding to the text to be processed;
decoding, by the waveform decoder, the intermediate representation to obtain speech data corresponding to the text to be processed.

Optionally, the speech synthesis model further comprises a training unit for:
acquiring sample data and inputting the sample data into a speech synthesis network, wherein the sample data comprises a sample text and a linear sonogram of sample speech data corresponding to the sample text;
generating, by the speech synthesis network and based on the sample data, approximate posterior distribution of prosodic features of each phoneme in the sample text;
performing, based on the approximate posteriori distribution, feedback regulation on parameters of the speech synthesis network to generate the speech synthesis model.

Optionally, the speech synthesis network comprises a posteriori encoder; the training unit is specifically used for:
generating, by the posteriori encoder and based on the linear sonogram and linguistic features of the sample text, prosodic features at a phoneme level of the sample text;
performing, by the posteriori encoder, linear transformation to the prosodic features at a phoneme level of the sample text to obtain approximate posterior distribution of the prosodic features of each phoneme in the sample text.

Optionally, the training unit is also specifically adapted to:
generating, by the posteriori encoder and based on the linear sonogram and linguistic features of the sample text, first prosodic features at a frame level of the sample text;
performing, by the posteriori encoder, matrix conversion on the first prosodic features at a frame level of the sample text to obtain the prosodic features at a phoneme level of the sample text.

Optionally, the training unit is specifically for:
performing the re-parametrization processing on the approximate posterior distribution to obtain a prosodic latent variable at a phoneme level corresponding to the sample text;
performing, based on the prosodic latent variable and the approximate posterior distribution, feedback regulation on parameters of the speech synthesis network to generate the speech synthesis model.

Optionally, the speech synthesis network comprises the prosodic predictor; the training unit is also specifically used for:
determining, by the prosodic predictor, distribution information about prosodic features of each phoneme in the sample text;
performing, based on the prosodic latent variable, the approximate posterior distribution and the distribution information about prosodic features of each phoneme in the sample text, feedback regulation on the parameters of the speech synthesis network to generate the speech synthesis model.

Optionally, the speech synthesis network comprises an posteriori waveform encoder, and the training unit is also specifically used for:
generating, according to the prosodic latent variable, a first intermediate representation corresponding to the sample text and prior distribution of prosodic features of each phoneme in the sample text;
encoding, by the posterior waveform encoder, the linear sonogram to obtain a second intermediate representation corresponding to the sample text;
performing, according to the first intermediate representation, the second intermediate representation, the approximate posterior distribution, the distribution information about prosodic features of each phoneme in the sample text and the prior distribution, feedback regulation on parameters of the speech synthesis network to generate the speech synthesis model.

Optionally, the speech synthesis network comprises the acoustic encoder; the training unit is also specifically used for:
converting, by the acoustic encoder, a prosodic latent variable at a phoneme level corresponding to the sample text to obtain second prosodic features at a frame level of the sample text;
performing, by the acoustic encoder and according to the second prosodic features at the frame level of the sample text, acoustic encoding on linguistic features of the sample text to obtain the first intermediate representation corresponding to the sample text.

Optionally, the training unit is also specifically adapted to:
performing normalized flow processing on the prosodic implicit variable to obtain the prior distribution of prosodic features of each phoneme in the sample text.

Optionally, the training unit is also specifically adapted to:
determining, according to the approximate posterior distribution, the prior distribution, and a likelihood function of the linear sonogram, a marginal log-likelihood lower bound of fit distribution of the linear sonogram;
performing, according to the first intermediate representation, the second intermediate representation, the approximate posterior distribution, the distribution information about prosodic features of each phoneme in the sample text, and the marginal log-likelihood lower bound, feedback regulation on parameters of the speech synthesis network to generate the speech synthesis model.

Optionally, the speech synthesis network comprises the waveform decoder; the training unit is also specifically used for:
decoding, by the waveform decoder, the first intermediate representation and the second intermediate representation respectively to obtain a first waveform and a second waveform;
performing, according to the first waveform, the second waveform, the approximate posterior distribution, the distribution information about prosodic features of each phoneme in the sample text, the marginal log-likelihood lower bound, feedback regulation on parameters of the speech synthesis network to generate the speech synthesis model.

Optionally, the training unit is also specifically adapted to:
determining a degree of similarity between the first waveform and the second waveform;
determining a divergence between the approximate posterior distribution and distribution information about prosodic features of each phoneme in the sample text;
performing, according to the degree of similarity, the divergence, the marginal log-likelihood lower bound, feedback regulation on the parameters of the speech synthesis network to generate the speech synthesis model.

Optionally, the speech synthesis network comprises the duration predictor, and the training unit is also specifically used for:
predicting, by the duration predictor and based on the prosodic latent variable, a pronunciation duration of each phoneme in the sample text;
inversely adjusting, according to a pronunciation duration of each phoneme in sample speech data corresponding to the sample text and a predicted pronunciation duration, parameters of the duration predictor.

The speech synthesis apparatus in the embodiments of the present disclosure can implement the respective processes of the embodiments of the speech synthesis method described above and achieve the same effects and functions. It would not be repeated here.

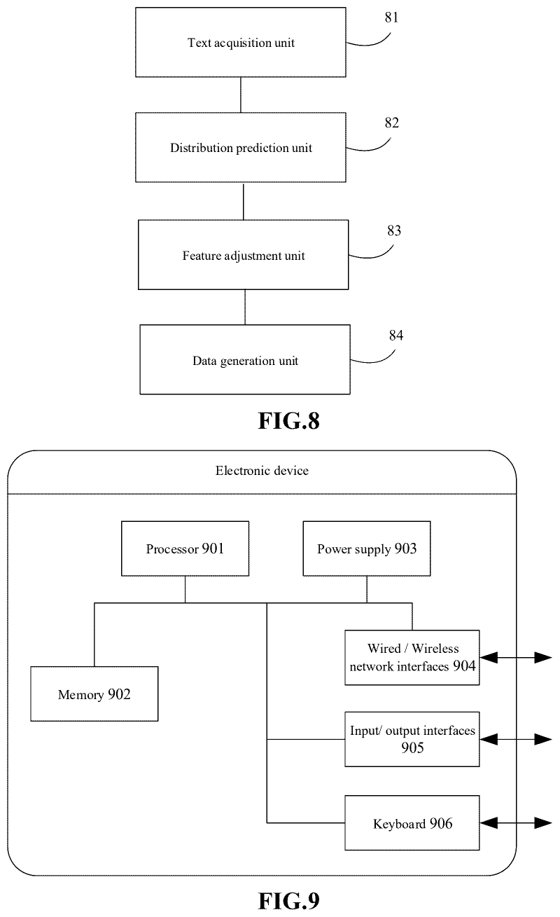

An embodiment of the present disclosure also provides an electronic device. FIG. 9 illustrates a structure diagram of an electronic device according to an embodiment of the present disclosure. As shown in FIG. 9, the electronic device may have a relatively large difference due to different configurations or performances, and may comprise one or more processors 901 and a memory 902 storing one or more applications or data. The memory 902 can be transient storage or persistent storage. The applications stored in the memory 902 may include one or more modules (not shown), and each of which may include a series of computer-executable instructions in an electronic device. Further, the processor 901 can be configured to communicate with the memory 902 to execute a series of computer-executable instructions in the memory 902 on the electronic device. The electronic device may also include one or more power supplies 903, one or more wired or wireless network interfaces 904, one or more input or output interfaces 905, and one or more keyboards 906, etc.

In a specific embodiment, the electronic device comprises a processor; and a memory configured to store computer-executable instructions that, when executed, cause the processor to implement the following process:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, linguistic features of the text to be processed;
generating, according to the adjusted linguistic features of the text to be processed, speech data corresponding to the text to be processed.

The electronic device in the embodiments in the disclosure can implement the various processes of the above-described embodiments of the speech synthesis method and achieve the same effects and functions. It would not be repeated here.

Another embodiment of the present disclosure also provides a computer-readable storage medium for storing computer-executable instructions that, when executed by a processor, implement the following process:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, linguistic features of the text to be processed;
generating, according to the adjusted linguistic features of the text to be processed, speech data corresponding to the text to be processed.

The storage medium in the embodiments of the present disclosure can implement the processes of the above-described speech synthesis method embodiments and achieve the same effects and functions. It would not be repeated here.

In various embodiments of the present disclosure, the computer-readable storage medium includes read-only Memory (ROM), random Access Memory (RAM), magnetic or optical disks, etc.

In the 1990s, improvements to a technology could clearly distinguish between improvements in hardware (e. g., improvements to circuit structures such as diodes, transistors, switches, etc.) and improvements in software (improvements to process flow). However, as technology advances, many of today's process flow improvements have been seen as direct improvements in hardware circuit architectures. Designers have almost always obtained the corresponding hardware circuit structure by programming the improved method flow into the hardware circuit. Therefore, it cannot be said that the improvement of a method flow cannot be realized with hardware entity modules. For example, a Programmable Logic Device (PLD), such as a Field Programmable Gate Array (FPGA), is an integrated circuit whose logic function is determined by a user programming the device. Designers program themselves to “integrate” a digital system onto a PLD without having to ask chip manufacturers to design and fabricate dedicated integrated circuit chips. In addition, today, instead of manually making integrated circuit chips, such programming is mostly implemented by using “logic compiler” software, which is similar to the software compiler used in program development and writing, and the original code before compilation is also written by using a specific programming language, which is called Hardware Description Language (HDL), and HDL is not only one but many kinds. Such as ABEL (Advanced Boolean Expression Language), AHDL (Altera Hardware Description Language), confluence, CUPL (Cornell University Programming Language), HDCal, JHDL (Java Hardware Description Language), lava, lola, myHDL, PALASM, RHDL (Ruby Hardware Description Language), etc. VHDL (Very-High-Speed Integrated Circuit Hardware Description Language) and Verilog are currently most commonly used. It will also be apparent to those skilled in the art that a hardware circuit implementing a logical method flow may be readily obtained by simply logically programming the method flow in the several hardware description languages described above and into an integrated circuit.

The controller may be implemented in any suitable manner, for example, the controller may take the form of, for example, a microprocessor or processor and a computer-readable medium storing computer-readable program code (e. g., software or firmware) executable by the (micro) processor, logic gates, switches, an Application Specific Integrated Circuit (ASIC), a programmable logic controller, and an embedded microcontroller, examples of which include, but are not limited to, the following microcontrollers: ARC 625D, atmel AT91 SAM, microchip PIC18F26K20, and Silicone Labs C8051F320, the memory controller may also be implemented as part of the control logic of the memory. Those skilled in the art will also appreciate that, in addition to implementing controllers in purely computer readable program code, method steps may well be logically programmed to cause controllers to perform the same functions in the form of logic gates, switches, application specific integrated circuits, programmable logic controllers, embedded microcontrollers, and the like. Such a controller may thus be regarded as a hardware component, and the means for performing the various functions comprised therein may also be regarded as a structure within the hardware component. Or even, the means for achieving the various functions may be seen as a structure within both the software modules and the hardware components implementing the method.

The system, device, module or unit illustrated in the above embodiments may be embodied in a computer chip or entity, or may be embodied in an article of manufacture having a functionality. A typical implementation is a computer. In particular, the computer may be, for example, a personal computer, a laptop computer, a cellular phone, a camera phone, a smart phone, a personal digital assistant, a media player, a navigation device, an e-mail device, a game console, a tablet computer, a wearable device, or a combination of any of these.

For convenience of description, the above apparatus is described with functions divided into various units, respectively. Of course, the functionality of the various elements may be implemented in the same or multiple pieces of software and/or hardware in practicing the disclosed embodiments.

One skilled in the art will appreciate that one or more embodiments of the present disclosure may be provided as a method, system, or computer program product. Accordingly, one or more embodiments of the present disclosure may take the form of an entirely hardware embodiment, an entirely software embodiment or an embodiment combining software and hardware aspects. Moreover, one or more embodiments of the present disclosure may take the form of a computer program product embodied on one or more computer-usable storage media (including, but not limited to, disk storage, CD-ROM, optical storage, etc.) having computer-usable program code embodied therein.

The present disclosure is described with reference to flowchart illustrations and/or block diagrams of methods, apparatus (systems), and computer program products according to embodiments of the disclosure. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart flow or flows and/or block diagram block or blocks.

These computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart flow or flows and/or block diagram block or blocks.

It should also be noted that the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises. A” does not, without more constraints, preclude the existence of additional identical elements in the process, method, article, or apparatus that comprises the element.

One or more embodiments of the present disclosure may be described in the general context of computer-executable instructions, such as program modules, being executed by a computer. Generally, program modules include routines, programs, objects, components, data structures, etc. That perform particular tasks or implement particular abstract data types. One or more embodiments of the present disclosure may also be practiced in distributed computing environments where tasks are performed by remote processing devices that are linked through a communications network. In a distributed computing environment, program modules may be located in both local and remote computer storage media including memory storage devices.

Each embodiment of the present disclosure is described in a progressive manner, with like references to each other throughout the various embodiments, with each embodiment focusing on the differences from the other embodiments. In particular, for system embodiments, which are substantially similar to method embodiments, the description is relatively simple with reference to the description of the method embodiments.

The foregoing is merely an example of the present disclosure and is not intended to limit the present disclosure. Various modifications and alterations to this disclosure will become apparent to those skilled in the art. It is intended that the following appended claims be interpreted as including all such alterations, permutations, and equivalents as fall within the true spirit and scope of the present disclosure.

1. A speech synthesis method comprising:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, the linguistic features of the text to be processed; and
generating, according to the adjusted linguistic features of the text to be processed, speech data corresponding to the text to be processed.

2. The method of claim 1, wherein the speech synthesis model comprises a text encoder and a prosodic predictor, and predicting, by the speech synthesis model and according to the linguistic features of the text to be processed, the distribution information about the prosodic features of each phoneme in the text to be processed comprises:
extracting the linguistic features of the text to be processed by the text encoder; and
predicting, by the prosodic predictor and according to the linguistic features of the text to be processed, the distribution information about the prosodic features of each phoneme in the text to be processed.

3. The method according to claim 1, wherein adjusting, based on the distribution information about the prosodic features of each phoneme in the text to be processed, the linguistic features of the text to be processed comprises:
predicting, based on the distribution information about the prosodic features of each phoneme in the text to be processed and the linguistic features of the text to be processed, a pronunciation duration of each phoneme in the text to be processed; and
performing, according to the pronunciation duration of each phoneme in the text to be processed, length amplification on the linguistic features of the text to be processed to obtain the adjusted linguistic features of the text to be processed.

4. The method of claim 3, wherein the speech synthesis model comprises a duration predictor, and predicting, based on the distribution information about the prosodic features of each phoneme in the text to be processed and the linguistic features of the text to be processed, the pronunciation duration of each phoneme in the text to be processed comprises:
performing a re-parameterization processing on the distribution information about the prosodic features of each phoneme in the text to be processed to obtain a prosodic latent variable at a phoneme level corresponding to the text to be processed; and
predicting, by the duration predictor and according to the prosodic latent variable at the phoneme level corresponding to the text to be processed and the linguistic features of the text to be processed, the pronunciation duration of each phoneme in the text to be processed.

5. The method of claim 1, wherein the speech synthesis model comprises an acoustic encoder and a waveform decoder, and generating, according to the adjusted linguistic features of the text to be processed, the speech data corresponding to the text to be processed comprises:
performing, by the acoustic encoder, acoustic encoding on the adjusted linguistic features of the text to be processed to obtain an intermediate representation corresponding to the text to be processed; and
decoding, by the waveform decoder, the intermediate representation to obtain the speech data corresponding to the text to be processed.

6. The method according to claim 1, wherein the speech synthesis model is trained by:
acquiring sample data and inputting the sample data into a speech synthesis network, wherein the sample data comprises a sample text and a linear sonogram of sample speech data corresponding to the sample text;
generating, by the speech synthesis network and based on the sample data, approximate posterior distribution of the prosodic features of each phoneme in the sample text; and
performing, based on the approximate posterior distribution, feedback regulation on parameters of the speech synthesis network to generate the speech synthesis model.

7. The method of claim 6, wherein the speech synthesis network comprises a posteriori encoder, and generating, by the speech synthesis network and based on the sample data, the approximate posterior distribution of the prosodic features of each phoneme in the sample text comprises:
generating, by the posteriori encoder and based on the linear sonogram and linguistic features of the sample text, prosodic features at a phoneme level of the sample text; and
performing, by the posteriori encoder, linear transformation to the prosodic features at the phoneme level of the sample text to obtain the approximate posterior distribution of the prosodic features of each phoneme in the sample text.

8. The method of claim 7, wherein generating, by the posteriori encoder and based on the linear sonogram and the linguistic features of the sample text, the prosodic features at the phoneme level of the sample text comprises:
generating, by the posteriori encoder and based on the linear sonogram and the linguistic features of the sample text, first prosodic features at a frame level of the sample text; and
performing, by the posteriori encoder, matrix conversion on the first prosodic features at the frame level of the sample text to obtain the prosodic features at the phoneme level of the sample text.

9. The method of claim 6, wherein performing, based on the approximate posterior distribution, the feedback regulation on the parameters of the speech synthesis network to generate the speech synthesis model comprises:
performing a re-parametrization processing on the approximate posterior distribution to obtain a prosodic latent variable at a phoneme level corresponding to the sample text; and
performing the feedback regulation on the parameters of the speech synthesis network to generate the speech synthesis model based on the prosodic latent variable and the approximate posterior distribution.

10. The method of claim 9, wherein the speech synthesis network comprises a prosodic predictor, and performing, based on the prosodic latent variable and the approximate posterior distribution, the feedback regulation on the parameters of the speech synthesis network to generate the speech synthesis model comprises:
determining, by the prosodic predictor, the distribution information about the prosodic features of each phoneme in the sample text; and
performing, based on the prosodic latent variable, the approximate posterior distribution and the distribution information about the prosodic features of each phoneme in the sample text, the feedback regulation on the parameters of the speech synthesis network to generate the speech synthesis model.

11. The method of claim 10, wherein the speech synthesis network comprises a posteriori waveform encoder, and performing, based on the prosodic latent variable, the approximate posterior distribution and the distribution information about the prosodic features of each phoneme in the sample text, the feedback regulation on the parameters of the speech synthesis network to generate the speech synthesis model comprises:
generating, according to the prosodic latent variable, a first intermediate representation corresponding to the sample text and prior distribution of the prosodic features of each phoneme in the sample text;
encoding, by the posteriori waveform encoder, the linear sonogram to obtain a second intermediate representation corresponding to the sample text; and
performing, according to the first intermediate representation, the second intermediate representation, the approximate posterior distribution, the distribution information about the prosodic features of each phoneme in the sample text and the prior distribution, the feedback regulation on the parameters of the speech synthesis network to generate the speech synthesis model.

12. The method of claim 11, wherein the speech synthesis network comprises an acoustic encoder, and generating the first intermediate representation corresponding to the sample text according to the prosodic latent variable comprises:
converting, by the acoustic encoder, the prosodic latent variable at the phoneme level corresponding to the sample text to obtain second prosodic features at a frame level of the sample text; and
performing, by the acoustic encoder and according to the second prosodic features at the frame level of the sample text, acoustic encoding on the linguistic features of the sample text to obtain the first intermediate representation corresponding to the sample text.

13. The method of claim 11, wherein generating, based on the prosodic latent variable, the prior distribution of the prosodic features of each phoneme in the sample text comprises:
performing normalized flow processing on a prosodic implicit variable to obtain the prior distribution of the prosodic features of each phoneme in the sample text.

14. The method of claim 11 wherein performing, according to the first intermediate representation, the second intermediate representation, the approximate posterior distribution, the distribution information about the prosodic features of each phoneme in the sample text and the prior distribution, the feedback regulation on the parameters of the speech synthesis network to generate the speech synthesis model comprises:
determining, according to the approximate posterior distribution, the prior distribution, and a likelihood function of the linear sonogram, a marginal log-likelihood lower bound of fit distribution of the linear sonogram; and
performing, according to the first intermediate representation, the second intermediate representation, the approximate posterior distribution, the distribution information about the prosodic features of each phoneme in the sample text, and the marginal log-likelihood lower bound, the feedback regulation on the parameters of the speech synthesis network to generate the speech synthesis model.

15. The method of claim 14, wherein the speech synthesis network comprises a waveform decoder, and performing, according to the first intermediate representation, the second intermediate representation, the approximate posterior distribution, the distribution information about the prosodic features of each phoneme in the sample text, and the marginal log-likelihood lower bound, the feedback regulation on the parameters of the speech synthesis network to generate the speech synthesis model comprises:
decoding, by the waveform decoder, the first intermediate representation and the second intermediate representation respectively to obtain a first waveform and a second waveform; and
performing, according to the first waveform, the second waveform, the approximate posterior distribution, the distribution information about the prosodic features of each phoneme in the sample text, the marginal log-likelihood lower bound, the feedback regulation on the parameters of the speech synthesis network to generate the speech synthesis model.

16. The method of claim 15, wherein performing, according to the first waveform, the second waveform, the approximate posterior distribution, the distribution information about the prosodic features of each phoneme in the sample text, the marginal log-likelihood lower bound, the feedback regulation on the parameters of the speech synthesis network to generate the speech synthesis model comprises:
determining a degree of similarity between the first waveform and the second waveform;
determining a divergence between the approximate posterior distribution and the distribution information about the prosodic features of each phoneme in the sample text; and
performing, according to the degree of similarity, the divergence, the marginal log-likelihood lower bound, the feedback regulation on the parameters of the speech synthesis network to generate the speech synthesis model.

17. The method of claim 9, wherein the speech synthesis network comprises a duration predictor, and the duration predictor is trained by:
predicting, by the duration predictor and based on the prosodic latent variable, a pronunciation duration of each phoneme in the sample text; and
inversely adjusting, according to a pronunciation duration of each phoneme in sample speech data corresponding to the sample text and a predicted pronunciation duration, parameters of the duration predictor.

18-20. (canceled)

21. An electronic device, comprising:
a processor; and
a memory configured to store computer-executable instructions that, when executed, cause the processor to implement a speech synthesis method comprising:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, the linguistic features of the text to be processed; and
generating, according to the adjusted linguistic features of the text to be processed, speech data corresponding to the text to be processed.

22. The electronic device of claim 21, wherein the speech synthesis model comprises a text encoder and a prosodic predictor, and predicting, by the speech synthesis model and according to the linguistic features of the text to be processed, the distribution information about the prosodic features of each phoneme in the text to be processed comprises:
extracting the linguistic features of the text to be processed by the text encoder; and
predicting, by the prosodic predictor and according to the linguistic features of the text to be processed, the distribution information about the prosodic features of each phoneme in the text to be processed.

23. A non-transitory computer-readable storage medium, wherein the computer-readable storage medium is configured to store computer-executable instructions that, when executed by a processor, implement a speech synthesis method comprising:
acquiring a text to be processed, and inputting the text to be processed into a speech synthesis model;
predicting, by the speech synthesis model and according to linguistic features of the text to be processed, distribution information about prosodic features of each phoneme in the text to be processed;
adjusting, based on the distribution information about the prosodic features of each phoneme in the text to be processed, the linguistic features of the text to be processed; and
generating, according to the adjusted linguistic features of the text to be processed, speech data corresponding to the text to be processed.
